(19) United States
(12) Patent Application Publication
(10) Pub. No.: US 2014/0127397 A1
(43) Pub. Date: May 8, 2014

(54) PROCESS FOR THE PREPARATION OF KISH GRAPHITIC LITHIUM-INSERTION ANODE MATERIALS FOR LITHIUM-ION BATTERIES

(71) Applicants: Thrivikraman Prem Kumar, Tamil Nadu (IN); Ashok Kumar Shukla, Tamil Nadu (IN); Thanudass Sri Devi Kumari, Tamil Nadu (IN); Arul Manuel Stephan, Tamil Nadu (IN)

(72) Inventors: Thrivikraman Prem Kumar, Tamil Nadu (IN); Ashok Kumar Shukla, Tamil Nadu (IN); Thanudass Sri Devi Kumari, Tamil Nadu (IN); Arul Manuel Stephan, Tamil Nadu (IN)

(73) Assignee: COUNCIL OF SCIENTIFIC & INDUSTRIAL RESEARCH, New Delhi (IN)

(21) Appl. No.: 14/123,387

(22) PCT Filed: May 25, 2012
(86) PCT No.: PCT/IN2012/000368

§ 371 Date: Dec. 2, 2013

(30) Foreign Application Priority Data
Jun. 3, 2011 (IN) 1577/DEL/2011

(51) Int. Cl. H01M 4/04

(52) U.S. Cl. CPC H01M 4/0402
USPC 427/122

(57) ABSTRACT

The present invention provides a process for the production of high-capacity kish graphitic lithium-insertion anode materials and negative electrodes prepared therefrom for lithium-ion batteries. The graphitic materials are produced by precipitating excess carbon present in supersaturated solutions of carbon in iron/steel uninoculated or inoculated with metals/metalloid singly or in combination. The form of carbon used for dissolution is a carbon-containing polymeric precursor such as biomaterials and non-biodegradable plastic wastes, the carbonization of which can be carried out in situ or prior to addition in the melt. The graphitic products deliver reversible capacities between 300 and 600 mAh·g−1 with flat voltage profiles for electrochemical insertion/deinsertion of lithium at potentials less than 200 mV.

### FIELD OF INVENTION

The present invention relates to kish graphitic lithium-insertion anode materials and negative electrodes prepared therefrom. Particularly the present invention relates to the production of kish graphite with high reversible capacities useful as active materials in negative electrode materials in lithium-ion batteries by a simple, inexpensive method from organic polymeric waste precursors.

The kish graphite prepared according to the present invention can be used for high-capacity negative electrodes in lithium-ion batteries. The method also provides a process for the production of such graphite from natural and synthetic organic polymers including non-biodegradable plastics or mixtures thereof. The graphitic products deliver reversible capacities between 300 and 600 mAh·g⁻¹ with flat voltage profiles for electrochemical insertion/deinsertion of lithium at potentials less than 200 mV v.

### BACKGROUND OF THE INVENTION & DESCRIPTION OF PRIOR ART

Lithium-ion batteries and lithium-ion polymer batteries commonly employ carbonaceous materials as active materials in their negative electrodes. Both natural and synthetic carbons have been examined for their lithium insertion properties for possible application as anodes in lithium-ion batteries. Electrochemical lithium insertion-deinsertion behavior of carbonaceous materials depend on a number of structural and morphological features of the host material including particle size, surface area, surface texture, degree of crystallinity, hydrogen content and the nature of surface functional groups. Candidate carbon materials for anode-active materials in lithium-ion batteries come broadly in two forms: graphitic and disordered.

Disordered carbons lack long-range crystalline ordering. They often contain substantial amounts of hydrogen and exhibit lithium insertion capacities much larger than the 372 mAh·g⁻¹ theoretically possible with perfectly graphitic structures. Moreover, they have sloping discharge profiles, which translate to decreasing cell voltages as the discharge proceeds. Reference may, for example, be made to the works of T. Zheng, J. S. Xue, J. R. Dahn, Chem. Mater. 8 (1996) 389; H. Fujimoto, A. Mabuchi, K. Tokumitsu, T. Kasuh, J. Power Sources 54 (1995) 440; S. Yata, Y. Hato, H. Kinoshita, N. Ando, A. Anekawa, T. Hashimoto, M. Yamaguchi, K. Tanaka, T. Yamabe, Synth. Met. 73 (1995) 273; Y. Mori, T. Iriyama, T. Hashimoto, S. Yamazaki, F. Kawakami, H. Shiroki, T. Yamabe, J. Power Sources 56 (1995) 205; and J.S. Xue, J. R. Dahn, J. Electrochem. Soc. 142 (1995) 3668, which report lithium-insertion capacities much in excess of 372 mAh·g⁻¹. An added disadvantage of such carbons is the large hysteresis in their charge-discharge profiles. On the other hand, graphitic carbons have only moderately high lithium storage capacities, limited to 372 mAh·g⁻¹ by the highest stoichiometry of LiC₆ of the lithiated carbon. However, their relatively flat potential profiles close to the redox potential of the Li⁺/Li couple, facile kinetics and reversibility of the lithium intercalation process, safety, non-toxicity and low cost make them attractive as lithium insertion anode materials.

Synthetic production of graphitic materials from soft or graphitizable carbons involves the application of high temperatures, often above 2,800° C., which makes graphitization process energy-intensive and expensive. Accordingly, there exists a need for a low-cost production process for carbonaceous anode-active materials that possess desirable electrochemical features of graphitic and disordered carbons, especially flat discharge profiles at potentials close to that of lithium, reversible capacities surpassing the theoretical value of graphitic and exhibiting very low hysteresis in their charge-discharge profiles. The desirability of such anodes become more pertinent than ever before considering that several emerging application areas such as electric traction demand anodes with higher capacities.

Reference may be made to patent JP2000182617A2 “carbon material for lithium secondary battery electrode and its manufacture, and lithium secondary battery”, wherein the carbon material for a lithium secondary battery electrode is a carbon powder prepared by carbonizing and graphitizing kish graphite together with pitch, resin or a mixture thereof to prepare the electrode. However, the kish graphite described in this invention are prepared by a method different from that in known art and exhibit high capacities.

Reference may be made to the journal, “J. Electrochem. Soc. 137 (1990) 2009” wherein R. Fong, U. von Sacken and J. R. Dahn disclosed graphitic materials that can deliver capacities close to 372 mAh·g⁻¹, the theoretical lithium-intercalation capacity of graphite. However, this value of discharge capacity was achieved only under very low rates of current drain. Several reports are available in the open literature on the use of graphitic materials as anodes for lithium-ion batteries, although none of them claim capacities above 372 mAh·g⁻¹. The present invention addresses the shortcomings of the carbon varieties, providing a method for the production of kish graphitic materials that exhibit flat discharge profiles at potentials close to that of lithium, reversible capacities between 300 and 600 mAh·g⁻¹ and very low hysteresis in their charge-discharge profiles

The source of the kish graphitic anode materials described in this invention is gray cast iron. Grey cast iron, so called because of the grey color of its fracture surface, contains carbon in the form of graphite in a matrix that consists of ferrite, pearlite or a mixture of the two. Kish graphite is the carbon thrown out when a supersaturated solution of carbon in iron is cooled. In other words, the method of generating graphite between grain boundaries by cooling a supersaturated solution of carbon in iron, usually in the form of cast iron or pig iron, is a low-temperature alternative to the production of highly graphitic carbons. The size and shape in which the graphite is present in the matrix is largely a function of parameters such as the solidification temperature, cooling rate, inoculants and the nucleation state of the melt.

Graphitization of iron/steel castings is known for a long time in the ferrous metallurgy industry [U.S. Pat. No. 1,328,845 (1920); U.S. Pat. No. 3,615,209 ((1971); U.S. Pat. No. 2,415,196 (1947); U.S. Pat. No. 3,656,904 (1972); U.S. Pat. No. 4,299,620 (1981); U.S. Pat. No. 4,404,177 (1983); Japanese patent JP60246214 (1984); Japanese patent JP63210007 (1988); U.S. Pat. No. 6,022,518 (2000); U.S. Pat. No. 0,134,149 A1 (2007); T. Noda, Y. Sumiyoshi, N. Ito, Carbon, 6 (1968) 813; J. Derbyshire, A. E. B. Presland, D. L. Trimm, Carbon, 10 (1972), 114; J. Derbyshire, A. F. B. Presland, D. L. Trimm, Carbon 13 (1975) 111; J. Derbyshire, D. L. Trimm, Carbon 13 (1975) 189; S. B. Austerman, S. M. Myron, J. W. Wagner, Carbon 5 (1967) 549; Y. Hishiyama, A. Ono, T. Tsuzuku, Carbon 6 (1968) 203; A. Oberlin, J. P. Rouchy, Carbon 9 (1971) 39; A. Oya, S. Otani, Carbon 19 (1981) 391]. However, such graphitization processes are employed for the production of special cast irons with improved mechanical properties.

In this invention, the conditions of preparation of kish graphites are so modified as to yield products that possess structural and morphological features that facilitate facile and higher accommodation of lithium ions such that the modified kish graphites resulting therefrom exhibit excellent cyclability and lithium insertion capacities. The main objective of the present invention is to provide high-capacity graphitic negative electrodes for lithium-ion batteries and a method of preparing the same, which obviates the drawbacks of the prior art detailed above, which include moderate capacities exhibited by graphitic carbons, and large hysteresis and sloping discharge curves exhibited by disordered carbons.

Based on the prior art, wherein the applicability of disordered carbons, in spite of their high capacities, is limited by large hysteresis and sloping discharge curves and that of graphitic carbons, despite their flat discharge profiles, is limited by their moderate capacities, it is desirable to either suppress the hysteresis and sloping nature of disordered carbons or to enhance the capacity of graphitic carbons. In fact, Lee et al. (Y. H. Lee, K. C. Pan, Y. Y. Lin, V. Subramanian, T. Prem Kumar, G. T. K. Fey, Mater. Lett. 57 (2003) 1113; and Y. H. Lee, K. C. Pan, Y. Y. Lin, T. Prem Kumar, G. T. K. Fey, Mater. Chem. Phys. 82 (2003) 750) showed kish graphites obtained by the conventional method, wherein excess carbon in a supersaturated solution of carbon is precipitated as graphite upon cooling, exhibited not only a flat discharge profile but also capacities as high as 430 mAh·g⁻¹. The excess capacities of such electrodes were attributed to the presence of nanocarbon structures in the kish graphitic products used in them. Thus, it was shown that graphitic carbons could be synthesized at temperatures as low as 1,600° C. with petroleum coke as a carbon precursor and that such graphitic negative electrodes exhibited flat discharge curves and delivered capacities in excess of the 372 mAh·g⁻¹ that is theoretically possible with perfectly graphitic structures. It must, however, be noted that the deliverable capacities of these graphitic materials were much lower than those realizable with disordered carbons.

Reference is drawn to the publication: Pyrolitic carbon from biomass precursors as anode materials for lithium batteries, by Stephan A M, Kumar T P, Ramesh R, et al., MATERIALS SCIENCE AND ENGINEERING A-STRUCTURAL MATERIALS PROPERTIES MICROSTRUCTURE & PROCESSING Volume: 430 Issue: 1-2 Pages: 132-137 Published: Aug. 25, 2006. It may be appreciated that the method of production of carbon in the above paper is a simple carbonization process. Specifically, it was done by carbonizing banana fibers, wherein the biomass was treated with concentrated solutions of ZnCl2 or KOH under flowing nitrogen. This is conceptually different from the present invention, wherein the carbon is first dissolved in a melt of steel at high temperatures and precipitated out by cooling.

Thus, keeping in view the drawbacks of the prior art, the inventors of the present invention realized that there exists a dire need to provide a process for the preparation of kish graphitic carbons with high reversible capacities useful as negative electrode materials in lithium-ion batteries by a simple and relatively inexpensive process.

### OBJECTS OF THE INVENTION

The main objective of the present invention is to provide high-capacity kish graphitic lithium-insertion anode materials and negative electrodes prepared therefrom for lithium-ion batteries which obviates the drawbacks of the hitherto known prior art as detailed above.

Another objective of the present invention is to provide a method for preparing kish graphitic negative electrode materials whose reversible capacities exceed 372 mAh·g⁻, the theoretical lithium intercalation capacity of graphite.

Still another objective of the present invention is to provide a method for preparing high-capacity kish graphitic materials with flat voltage profiles in their discharge curves.

Yet another objective of the present invention is to provide a method for preparing high-capacity kish graphitic materials from natural and synthetic polymeric substances or mixtures thereof as precursors.

A further objective of the present invention is to provide a method for the production of high-capacity kish graphitic lithium-insertion anode materials from natural and synthetic polymeric materials including non-biodegradable plastic wastes or mixtures thereof.

Another objective of this invention is to provide a method for the production of high-capacity kish graphitic lithium-insertion anode materials whose structural and electrochemical features can be altered by the addition of metals/metalloids singly or in combination as inoculants in the steel melt from which the graphite is generated.

### BRIEF DESCRIPTION OF THE DRAWINGS

The present invention is illustrated in FIG. 1 to FIG. 4 of the drawings accompanying this specification.

FIG. 1 shows a typical metallurgical image of kish graphite precipitated between grain boundaries in the steel.

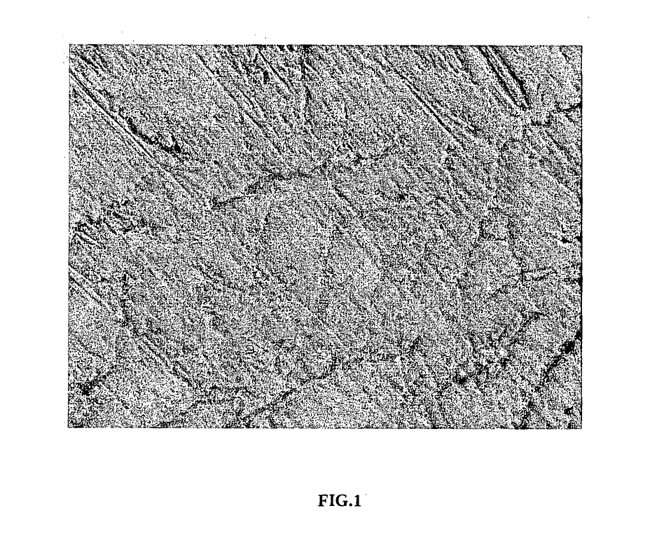

FIG. 2 shows a typical scanning electron microscopic image of the kish graphitic product derived by using bismuth as an inoculant.

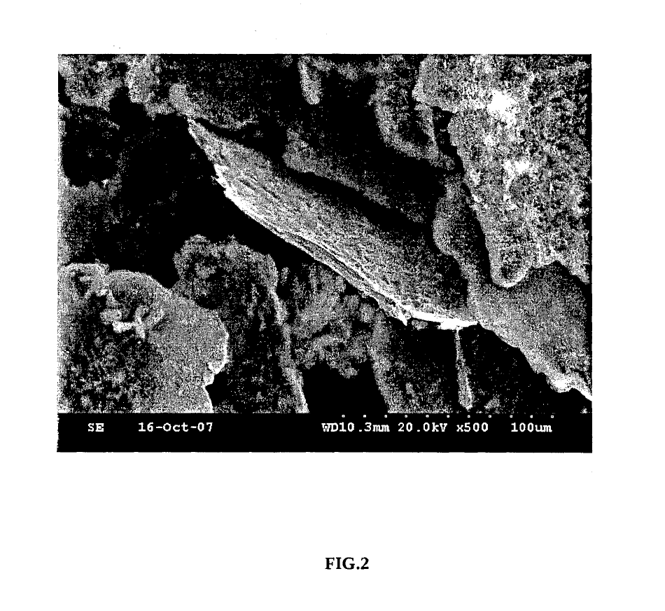

FIG. 3 shows a transmission electron microscopic image of kish graphite derived from polyvinyl chloride as a precursor, showing serpentine nanocarbon structures embedded in the graphitic matrix.

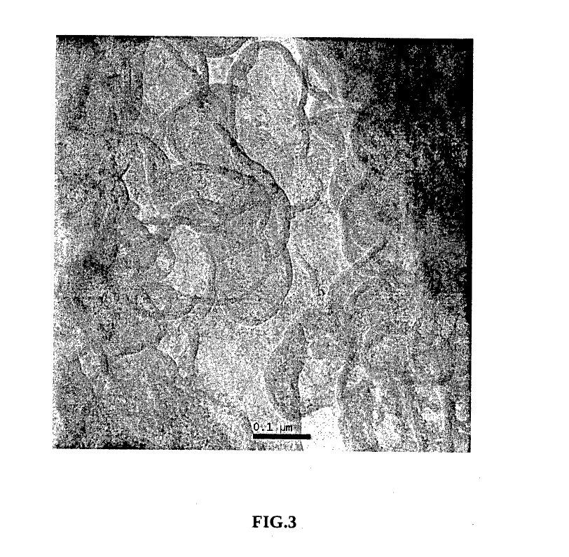

FIG. 4 shows the first charge-discharge profile of a kish graphitic product obtained with phenyl-formaldehyde resin as a carbon precursor.

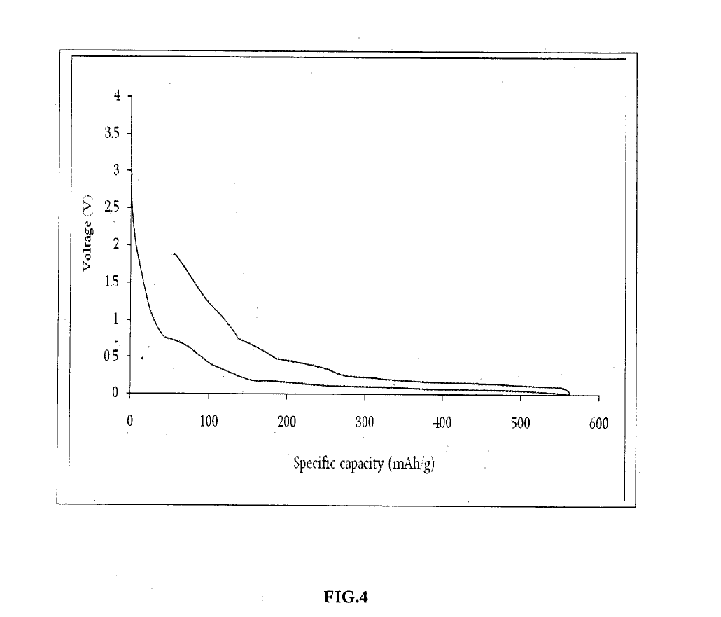

### SUMMARY OF THE INVENTION

The present invention provides a method for the preparation of kish graphitic lithium-insertion anode materials and negative electrodes prepared therefrom for lithium-ion batteries wherein the kish graphitic anode materials, exhibiting reversible capacities exceeding 372 mAh·g⁻ with flat discharge curves, are precipitated upon cooling from supersaturated solutions of carbon in iron melts, the precursors for the carbon being organic natural and synthetic polymeric substances including non-biodegradable plastic wastes or mixtures thereof.

Accordingly, the present invention provides a process for the preparation of kish graphitic lithium-insertion anode materials for lithium-ion batteries comprising the steps of:

(a) dissolving polymeric waste precursor in a melt of iron at a temperature in the range of 1,400 to 2,000° C. for a duration of 5 minutes to 120 minutes under reducing atmosphere of either flowing nitrogen or a blanket of carbon dioxide formed by the reaction of the carbon precursor with atmospheric oxygen top obtain a mixture;

(b) cooling the mixture as obtained in step (a) to a temperature in the range 1,000° C. to 1,400° C. at a rate in the range of 2 to 200° C. per minute to obtain the solid mass of precipitated carbon;

(c) cutting the solid mass of precipitated carbon as obtained in step (b) into ingots;

(d) leaching the ingots as obtained in step (c) with HCl and HF followed by filtering, washing and drying to obtain the kish graphite;

(e) preparing a slurry of kish graphite as obtained in step (d) with a conducting carbon and polyvinylidene fluoride binder in N-methyl-2-pyrrolidone;

(f) coating the slurry as obtained in step (e) on metal substrates followed by drying and pressing to obtain the lithium-insertion anode.

In an embodiment of the present invention, polymeric waste precursor comprising biomass waste and non-biodegradable plastic wastes is selected from the group consisting of, bagasse, natural rubber, bitumen, cellulose, sucrose, cellulose acetate, acrylonitrile-butadiene-styrene ter polymer, polyacrylamide, polyacrylic acid, polyacrylonitrile, polyamides, polybutadiene styrene rubber, polycarbonate, polychloroprene (neoprene rubber), polyesters, polyethylene, poly(methyl methacrylate), polypropylene, polytetrafluoroethylene, polyvinyl acetate, polyvinyl alcohol, polyvinyl chloride, polystyrene, polyvinylidene fluoride, polyurethanes and silicone, and resins such as phenol-formaldehyde resins.

In another embodiment of the present invention, the carbon content in the added polymeric waste precursor ranging from 2 to 20% by weight of the iron.

In still another embodiment of the present invention, the polymeric waste precursor is either carbonized in situ in the melt or added to the melt in a pre-carbonized form.

In yet another embodiment of the present invention, the melt of iron consists of cast iron or pig iron.

In still another embodiment of the present invention, the melt of iron is uninoculated or inoculated with metals/metalloids including antimony, bismuth, boron, chromium. magnesium, manganese, molybdenum, tin, titanium, vanadium and zirconium.

In yet another embodiment of the present invention, wherein the conducting carbon consists of natural graphite or carbon formed from partial oxidation of hydrocarbons.

In a further embodiment of the present invention, the slurry comprises kish graphite in the range of 50 to 95%, conducting carbon in the range 0 to 40% and polyvinylidene fluoride binder in N-methyl-2-pyrrolidone in the range 2 to 10%.

In another embodiment of the present invention, the metal substrate is selected from copper, nickel and stainless steel.

In yet another embodiment of the present invention, the total concentration of the metallic/metalloid inoculants is between 0 and 2% with respect to the steel.

In still another embodiment of the present invention, the kish graphitic anode materials exhibit reversible capacities between 300 and 600 mAh·g⁻¹ in coin cell configurations with metallic lithium and an electrolyte of 1M LiPF₆ in 1:1 (v/v) ethylene carbonate-diethyl carbonate between 3.000 and 0.005 V at a C/10 rate with respect to 372 mAh·g⁻¹ for stage-I LiC₆ composition at 25° C.

### DETAILED DESCRIPTION OF THE INVENTION

The present invention addresses the shortcomings of common varieties of graphitic and disordered carbons, providing a method for the production of kish graphitic materials that exhibit flat discharge profiles at potentials close to that of lithium, reversible capacities between 300 and 600 mAh·g⁻¹, and very low hysteresis in their charge-discharge profiles.

The invention provides a process for the production of high-capacity kish graphitic lithium-insertion anode materials and negative electrodes prepared therefrom for lithium-ion batteries, which comprises a method for the preparation of graphitic negative electrode materials that exhibit flat discharge curves with reversible capacities exceeding 372 mAh·g⁻¹(in the range of 300-600 mAh·g⁻¹). the method of preparation of the graphitic materials involving the use of carbon-containing natural and synthetic polymeric precursors that include, but hot limited to, bagasse, natural rubber, bitumen, cellulose, sucrose, cellulose acetate, acrylonitrile-butadiene-styrene terpolymer, polyacrylamide, polyacrylic acid, polyacrylonitrile, polyamides, polybutadiene styrene rubber, polycarbonate, polychloroprene (neoprene rubber), polyesters, polyethylene, poly(methyl methacrylate), polypropylene, polytetrafluoroethylene, polyvinyl acetate, polyvinyl alcohol, polyvinyl chloride, polystyrene, polyvinylidene fluoride, polyurethanes and silicones, and resins such as phenol-formaldehyde resin, the precursors or their mixtures being pre-carbonized in an inert atmosphere or simultaneously carbonized and then dissolved in a melt of cast iron or pig iron, uninoculated or inoculated with metals/metalloids that include, but not limited to antimony, bismuth, boron, chromium, magnesium, manganese, molybdenum, tin, titanium, vanadium and zirconium, and maintained under a reducing atmosphere at temperatures between 1,400 and 2,000° C., the carbon content in the added polymeric precursor ranging from 2 to 20% by weight of the iron, with the duration of carbon dissolution in the iron melt being between 5 minutes and 120 minutes and followed by cooling of the steel melt to temperature between 1,000 to 1,400° C. at a cooling rate between 2 and 200° C. per minute, the precipitated carbon separated from the metallic and non-metallic constituents by lixiviation with mineral acids, washed and dried, the dried product made into electrode structures by slurry-coating a mixture of the graphitic product with a conducting carbon, polyvinylidene fluoride binder in N-methyl-2-pyrrolidone on substrates such as copper, nickel, stainless steel, etc., the content of the graphitic product, conducting carbon and polyvinylidene fluoride in the coating, respectively, being between 50 to 95%, 0 to 25% and 2 to 10%, drying and pressing the coated electrodes, the resulting electrodes upon charging and discharging yielding reversible capacities in the range of 300-600 mAh·g⁻¹.

A large variety of kish graphitic products can be obtained depending on the kind of organic polymeric precursors used. A further variety can be introduced by use of metallic/metalloid inoculants in the steel melt. Dissolution of carbonizable precursors including biomaterials and non-biodegradable plastics in molten iron/steel, and inoculating the melt with metals/metalloids, steps that lead to kish graphitic materials with varied morphological features and with a variety of nanocarbon structures embedded in it.

The amount of the organic precursor should be such that the carbon derivable from the precursor should at least match the solubility of carbon in the steel at the temperature of dissolution but not exceeding 10% by weight over and above the solubility limit. Production of the said kish graphitic materials is based on a catalytic graphitization process by which the excess carbon present in supersaturated solutions of carbon in steel melts get precipitated upon cooling. A notable feature of this invention is that the carbon for dissolution is derived from carbon-containing natural and synthetic polymeric precursors including non-biodegradable plastic wastes that litter our surroundings. A further feature of this invention relates to structural and morphological modification of the product by use of metals/metalloids as inoculant in the steel melt from which the graphite is generated. Thus, this invention provides a method for conversion of inexpensive organic polymeric products including non-biodegradable plastic wastes that litter our surroundings into kish graphite useful as high-capacity anode-active materials in lithium-ion batteries.

The method of preparing the negative electrode according to this invention does not need to be discriminated as long as the method provides a negative electrode that has a good ability to impart shape and bestows chemical, thermal and electrochemical stability when used in a lithium-ion battery configuration. For example, it is often desirable to use an electrically. conducting matrix material such as carbon black and a fine powder or a dispersion or solution of a polymeric binding material such as carboxymethyl cellulose, polyethylene, polyvinyl alcohol, polytetrafluoroethylene and polyvinylidene fluoride in conjunction with the graphitic active material and then mixing and kneading them into a paste in a suitable medium such as water, N-methyl-2-pyrrolidone, hot-pressing or slurry-coating the resulting mixture, and cutting out electrodes of suitable sizes. However, because the kish graphitic product according to this invention is electrically conducting, it is not particularly necessary to have a further addition of a conducting carbon matrix material for the preparation of the negative electrode.

The negative electrode-active material according to the present invention is a mixed powder of a conducting matrix carbon material and a kish graphitic product according to this invention, the conducting carbon matrix material is preferred to have a behavior as a powder for making a slurry thereof in terms of particle size distribution, surface area, tap density and wettability, and the kish graphitic product derived from polyethylene as a polymeric precursor with pig iron containing manganese as the molten medium, gave a reversible capacity of 450 mAh·g⁻¹ at a C/10 charge and discharge rate calculated with respect to a value of 372 mAh·g⁻¹ for perfectly graphitic structures. The kish graphitic product derived from acrylonitrile-butadiene-styrene terpolymer with cast iron without any added inoculant as the molten medium, gave a capacity of 378 mAh·g⁻¹ between 3.000 and 0.005 V at a C/10 charge and discharge rate.

The present invention provides a method for generating graphitic materials suitable for use in the negative electrode of lithium-ion batteries. The novelty of the invention is that such technologically useful graphitic materials are generated from carbon-containing natural and synthetic polymeric precursors including non-biodegradable plastic wastes or mixtures thereof. In this respect, it provides a method to convert cheap polymeric waste materials that litter our surroundings, including non-biodegradable plastic wastes, into a technologically useful product.

The following examples are given by way of illustration only and therefore should not be construed to limit the scope of the present invention.

### EXAMPLE 1

To a melt of cast iron containing 50 ppm (0.005%) by weight of bismuth and maintained at 1,700° C., 2% by weight of bitumen was added. The temperature was maintained at 1,400° C. with the crucible kept rocking for 120 min. Subsequently, the melt was cooled to 1,000° C. at a rate of 2° C. per minute. The cooled solid mass was then cut into ingots of convenient sizes and leached with HC1 and HF. The resulting graphitic product was collected, filtered, washed and dried. A slurry containing 50% of the product, 40% conducting carbon and 10% polyvinylidene fluoride in N-methyl-2-pyrrolidone was coated on a copper substrate. A coin cell in which the coated electrode was coupled with metallic lithium in an electrolyte of 1M LiPF₆ in 1:1 (v/v) ethylene carbonate-diethyl carbonate mixture delivered reversible capacities of 311 mAh/g between 3.000 and 0.005 V at a C/10 rate with respect to 372 mAh·g⁻¹ for stage-I LiC₆ composition, with the entire voltage plateau region appearing below 200 mV vs. Li⁺/Li.

### EXAMPLE 2

To a melt of pig iron maintained at 1,800° C., carbon obtained by pre-carbonizing 10% by weight (w.r.t. iron) of polyvinyl chloride was added. The pre-carbonization was carried out separately in a graphite crucible under flowing nitrogen in a tubular furnace at 800° C. for 2 h. The temperature of the melt was maintained at 2,000° C. with the crucible kept rocking for 5 min. Subsequently, the melt was cooled to 1,400° C. at a rate of 200° C. per minute. The cooled solid mass was then cut into ingots of convenient sizes and leached with HCl and HF. The resulting graphitic product was collected, filtered, washed and dried. A slurry containing 95% of the product and 5% polyvinylidene fluoride in N-methyl-2-pyrrolidone was coated on a stainless steel substrate. A coin cell in which the coated electrode was coupled with metallic lithium in an electrolyte of 1M LiPF₆ in 1:1 (v/v) ethylene carbonate-diethyl carbonate mixture delivered reversible capacities of 352 mAh/g between 3.000 and 0.005 V at a C/10 rate with respect to 372 mAh·g⁻¹ for stage-I LiC₆ composition, with the entire voltage plateau region appearing below 180 mV vs. Li⁺/Li.

### EXAMPLE 3

To a melt of pig iron containing 2% by weight of zirconium and maintained at 1,800° C., acrylonitrile-butadiene-styrene terpolymer was added such that the amount of carbon derivable from the polymer was 20%. The temperature was maintained at 1,800° C. with the crucible kept rocking for 100 min. Subsequently, the melt was cooled to 1,400° C. at a rate of 50° C. per minute. The cooled solid mass was then cut into ingots of convenient sizes and leached with HCl and HF. The resulting graphitic product was collected, filtered, washed and dried. A slurry containing 80% of the product, 15% conducting carbon and 5% polyvinylidene fluoride in N-methyl-2-pyrrolidone was coated on a copper substrate. A coin cell in which the coated electrode was coupled with metallic lithium in an electrolyte of 1M LiPF₆ in 1:1 (v/v) ethylene carbonate-diethyl carbonate mixture delivered reversible capacities of 438 mAh/g between 3.000 and 0.005 V at a C/10 rate with respect to 372 mAh·g⁻¹ for stage-I LiC₆ composition, with the entire voltage plateau region appearing below 200 mV vs. Li⁺/Li.

### EXAMPLE 4

To a melt of pig iron maintained at 1,700° C., phenyl-formaldehyde resin was added such that the amount of carbon derivable from the polymer was 7%. The temperature was maintained at 1,700° C. with the crucible kept rocking for 40 min. Subsequently, the melt was cooled to 1,400° C. at a rate of 100° C. per minute. The cooled solid mass was then cut into ingots of convenient sizes and leached with HCl and HF. The resulting graphitic product was collected, filtered, washed and dried. A slurry containing 85% of the product, 10% conducting carbon and 5% polyvinylidene fluoride in N-methyl-2-pyrrolidone was coated on a copper substrate. A coin cell in which the coated electrode was coupled with metallic lithium in an electrolyte of 1M LiPF₆ in 1:1 (v/v) ethylene carbonate-diethyl carbonate mixture delivered reversible capacities of 562 mAh/g between 3.000 and 0.005 V at a C/10 rate with respect to 372 mAh·g⁻¹ for stage-I LiC₆ composition, with the entire voltage plateau region appearing below 200 mV vs. Li⁺/Li.

### EXAMPLE 5

To a melt of cast iron containing 0.5% by weight of magnesium and maintained at 1,800° C., polystyrene was added such that the amount of carbon derivable from the polymer was 8%. The temperature was maintained at 1,800° C. with the crucible kept rocking for 30 min. Subsequently, the melt was cooled to 1,200° C. at a rate of 50° C. per minute. The cooled solid mass was then cut into ingots of convenient sizes and leached with HCl and HF. The resulting graphitic product was collected, filtered, washed and dried. A slurry containing 70% of the product, 25% conducting carbon and 5% polyvinylidene fluoride in N-methyl-2-pyrrolidone was coated on a copper substrate. A coin cell in which the coated electrode was coupled with metallic lithium in an electrolyte of 1M LiPF₆ in 1:1 (v/v) ethylene carbonate-diethyl carbonate mixture delivered reversible capacities of 380 mAh/g between 3.000 and 0.005 V at a C/10 rate with respect to 372 mAh·g⁻¹ for stage-I LiC₆ composition, with the entire voltage plateau region appearing below 200 mV vs. Li⁺/Li.

### ADVANTAGES

The main advantages of the present invention are:
Production of kish graphitic carbons with high reversible capacities useful as negative electrode materials in lithium-ion batteries by a simple and relatively inexpensive process.
Use of relatively low temperatures for the graphitization process.
Use of a variety of carbonaceous and carbonizable precursors including biomaterials and bio-wastes.
High capacities of the kish graphitic products for the electrochemical intercalation reaction.
Extremely flat voltage profiles for electrochemical intercalation and deintercalation reactions, which appear entirely at potentials less than 200 mV vs. Li⁺/Li.

We claim:

1. A process for the preparation of kish graphitic lithium-insertion anode materials for lithium-ion batteries comprising the steps of:
(a) dissolving polymeric waste precursor in a melt of iron at a temperature in the range of 1,400 to 2,000° C. for a duration of 5 minutes to 120 minutes under reducing atmosphere of either flowing nitrogen or a blanket of carbon dioxide formed by the reaction of the carbon precursor with atmospheric oxygen top obtain a mixture;
(b) cooling the mixture as obtained in step (a) to a temperature in the range 1,000° C. to 1,400° C. at a rate in the range of 2 to 200° C. per minute to obtain the solid mass of precipitated carbon;
(c) cutting the solid mass of precipitated carbon as obtained in step (b) into ingots;
(d) leaching the ingots as obtained in step (c) with HCl and HF followed by filtering, washing and drying to obtain the kish graphite;
(e) preparing a slurry of kish graphite as obtained in step (d) with a conducting carbon and polyvinylidene fluoride binder in N-methyl-2-pyrrolidone;
(f) coating the slurry as obtained in step (e) on metal substrates followed by drying and pressing to obtain the lithium-insertion anode.

2. A process as claimed in step (a) of claim 1, wherein the polymeric waste precursor comprising biomass waste and non-biodegradable plastic wastes is selected from the group consisting of, bagasse, natural rubber, bitumen, cellulose, sucrose, cellulose acetate, acrylonitrile-butadiene-styrene terpolymer, polyacrylamide, polyacrylic acid, polyacrylonitrile, polyamides, polybutadiene styrene rubber, polycarbonate, polychloroprene (neoprene rubber), polyesters, polyethylene, poly(methyl methacrylate), polypropylene, polytetrafluoroethylene, polyvinyl acetate, polyvinyl alcohol, polyvinyl chloride, polystyrene, polyvinylidene fluoride, polyurethanes and silicones, and resins such as phenol-formaldehyde resins.

3. A process as claimed in step (a) of claim 1, wherein the carbon content in the added polymeric waste precursor ranging from 2 to 20% by weight of the iron.

4. A process as claimed in step (a) of claim 1, wherein the polymeric waste precursor is either carbonized in situ in the melt or added to the melt in a pre-carbonized form.

5. A process as claimed in step (a) of claim 1, wherein the melt of iron consists of cast iron or pig iron.

6. A process as claimed in step (a) of claim 1, wherein the melt of iron is uninoculated or inoculated with metals/metalloids including antimony, bismuth, boron, chromium. magnesium, manganese, molybdenum, tin, titanium, vanadium and zirconium.

7. A process as claimed in step (e) of claim 1, wherein the conducting carbon consists of natural graphite or carbon formed from partial oxidation of hydrocarbons.

8. A process as claimed in step (e) of claim 1, wherein the slurry comprises kish graphite in the range of 50 to 95%, conducting carbon in the range 0 to 40% and polyvinylidene fluoride binder in N-methyl-2-pyrrolidone in the range 2 to 10%.

9. A process as claimed in step (e) of claim 1, wherein the metal substrate is selected from copper, nickel and stainless steel.

10. A process as claimed in claim 5, wherein the total concentration of the metallic/metalloid inoculant is between 0 and 2% with respect to the steel.

11. A process as claimed in claim 1, wherein the kish graphitic anode materials exhibit reversible capacities between 300 and 600 mAh·g⁻¹ in coin cell configurations with metallic lithium and an electrolyte of 1M LiPF₆ in 1:1 (v/v) ethylene carbonate-diethyl carbonate between 3.000 and 0.005 V at a C/10 rate with respect to 372 mAh·g⁻¹ for stage-I LiC₆ composition at 25° C.
